(19) United States
(12) Patent Application Publication
(10) Pub. No.: US 2019/0056804 A1
(43) Pub. Date: Feb. 21, 2019

(54) MOUSE DEVICE

(71) Applicant: Primax Electronics Ltd., Taipei City (TW)

(72) Inventors: Chia-Yuan Chang, Taipei City (TW); Chun-Lin Chu, Taipei City (TW); Li-Kuei Cheng, Taipei City (TW); Wei-Hsiang Lin, Taipei City (TW); Shu-An Huang, Taipei City (TW); Tsun-Han Wu, Taipei City (TW)

(21) Appl. No.: 15/879,780

(22) Filed: Jan. 25, 2018

(30) Foreign Application Priority Data
Aug. 18, 2017 (TW) 106128125

(51) Int. Cl. G06F 3/0354; G06F 3/038; G06F 3/02

(52) U.S. Cl. CPC G06F 3/03543; G06F 2203/0333; G06F 3/0202; G06F 3/038

(57) ABSTRACT

The present invention provides a mouse device, including a housing, a flexible film, a support structure, a linking structure, and a motor. The flexible film covers an opening of the housing. The linking structure is connected between the motor and the support structure. The motor is configured to enable the linking structure to move to change an abutting state that the support structure abuts against the flexible film, thereby enabling the flexible film to deform.

### FIELD OF THE INVENTION

The present invention relates to the field of input apparatuses, and in particular, to a mouse device.

### BACKGROUND OF THE INVENTION

Technologies develop rapidly, and the era of multimedia and computer has come. In a computer system, input apparatuses connecting computer hosts and users play a very important role. The input apparatuses include mouse devices, keyboard devices, trackball devices, and the like. The mouse device may be held in hands by a user to control a cursor of a mouse to move, and manipulated by fingers of the user to click on and select an image or perform a function, so that the mouse device becomes a most common input apparatus.

Under a trend of being simple, convenient, and light, a volume and a size of the mouse device are gradually decreased, thereby increasing portability and operability. However, sizes of hand portions of people are not completely the same, so a mouse device of a fixed volume and size cannot accurately meet requirements of each people. Consequently, the hand portions of some users cannot be effectively supported when operating the mouse device, causing discomfort to the users and reducing the working efficiency during long time use of the mouse device.

In view of this, for the moment, a mouse device that may deform according to a size of a hand portion of a user is proposed, as disclosed in the US Patent Publication No. US2017/0192536. A volume and a size of the mouse device are changed mainly by rotating or moving outer components of the mouse device. However, in structure design, a gap between the outer components is relatively large, and an appearance of the mouse device is not flat. Consequently, a touch sense of the user for operating the mouse device is affected, and components within the mouse device cannot be protected neither. Therefore, the conventional mouse device may be improved.

### SUMMARY OF THE INVENTION

A main objective of the present invention is to provide a mouse device, and in particular, to a mouse device that may enable a user to adjust a volume and a size thereof while remaining flat in appearance.

In a preferred embodiment, the present invention provides a mouse device, including:

a housing, including an opening;

a flexible film, covering the opening;

a support structure, abutting against the flexible film in a direction towards outside of the housing;

a linking structure, one side thereof being connected to the support structure; and

a motor, disposed in the housing and connected to another side of the linking structure, and configured to enable the linking structure to move to change an abutting state that the support structure abuts against the flexible film, thereby enabling the flexible film to deform.

### BRIEF DESCRIPTION OF THE DRAWINGS

FIG. 1 is a conceptual schematic diagram that a mouse device is connected to a calculator device according to the present invention;

FIG. 2 is a schematic structural diagram of a mouse device in a first preferred embodiment according to the present invention;

FIG. 3 is a conceptual schematic block diagram of the mouse device shown in FIG. 2;

FIG. 4 is a schematic structural diagram of the mouse device shown in FIG. 2 that is adjusted by a user;

FIG. 5 is a schematic structural diagram of a mouse device in a second preferred embodiment according to the present invention;

FIG. 6 is a schematic structural diagram of the mouse device shown in FIG. 5 that is adjusted by a user;

FIG. 7 is a conceptual schematic block diagram of a mouse device in a third preferred embodiment according to the present invention; and

FIG. 8 is a conceptual schematic block diagram of a mouse device in a fourth preferred embodiment according to the present invention.

### DETAILED DESCRIPTION OF THE PREFERRED EMBODIMENT

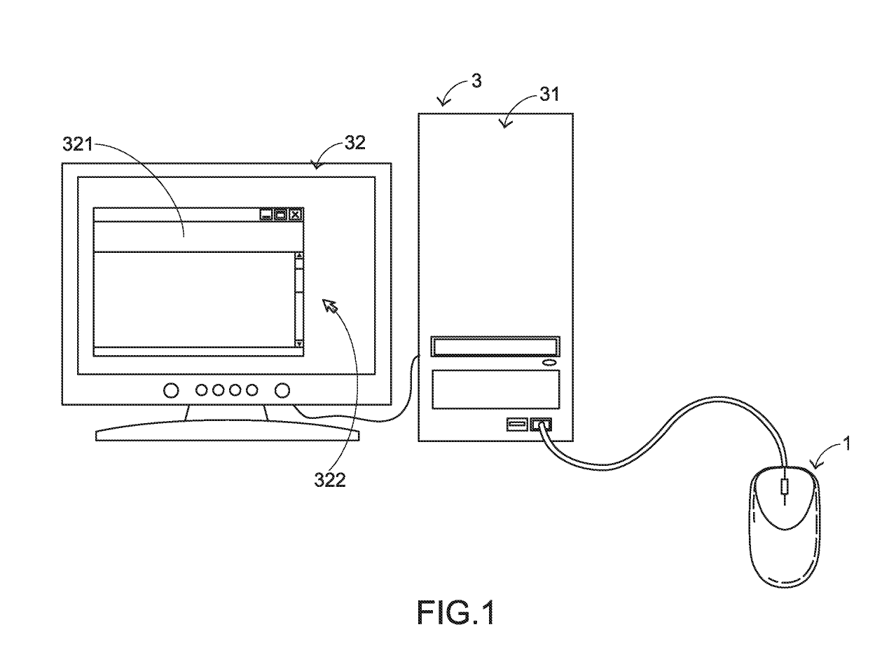

Referring to FIG. 1, FIG. 1 is a conceptual schematic diagram that a mouse device is connected to a calculator device according to the present invention. In this preferred embodiment, a calculator device 3 includes a computer host 31 and a computer screen 32. The computer host 31 is separately connected to a mouse device 1 and the computer screen 32. Although connection is achieved in a wired manner in FIG. 1, it is not limited thereto; and the connection may alternatively be achieved in a wireless manner. Moreover, the computer screen 32 may display a cursor 322 and a window 321. The mouse device 1 is held and moved by a palm of a user. The computer host 31 further moves the cursor 322 in the computer screen 32 according to a displacement of the mouse device 1. However, the specific implementation and operation principle that the user controls the cursor 322 in the computer screen 32 to move by using the mouse device 1 are known by a person skilled in the art, and details are not described herein again.

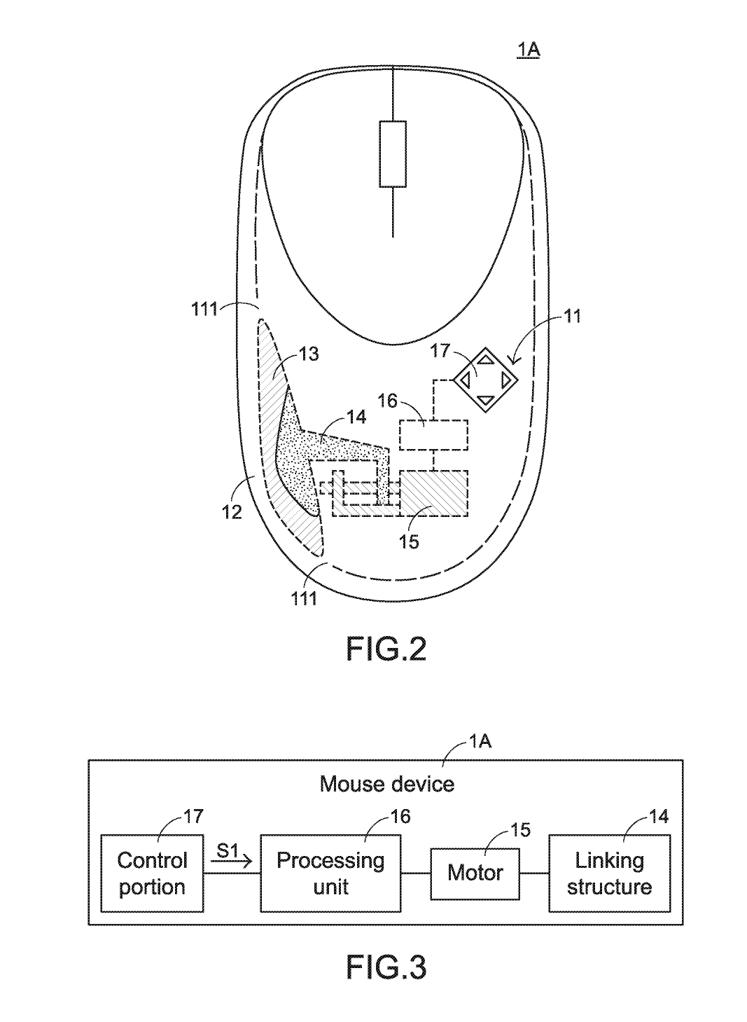

Referring to FIG. 2 and FIG. 3, FIG. 2 is a schematic structural diagram of a mouse device in a first preferred embodiment according to the present invention; and FIG. 3 is a conceptual schematic block diagram of the mouse device shown in FIG. 2. A mouse device 1A includes a housing 11, a flexible film 12, a support structure 13, a linking structure 14, a motor 15, a processing unit 16, and a control portion 17. The flexible film 12 covers an upper surface and a side surface of the housing 11. The motor 15, the processing unit 16, and at least a part of the linking structure 14 are located within the housing 11. Two sides of the linking structure 14 are respectively connected to the motor 15 and the support structure 13. The motor 15 is electrically connected to the processing unit 16. The housing 11 has an opening 111. Moreover, the support structure 13 is configured to abut against, by using the opening 111 of the housing 11, the flexible film 12 in a direction towards outside of the housing 11. However, the motor 15 may provide a power to move the linking structure 14, so as to change an abutting state that the support structure 13 abuts against the flexible film 12, thereby enabling the flexible film 12 to deform. In addition, the control portion 17 is used by the user to adjust the mouse device 1 to have a volume and a size that are fit for a hand portion of the user, and may be a mechanical control component, an optical control component, or a touch control component, but is not limited thereto.

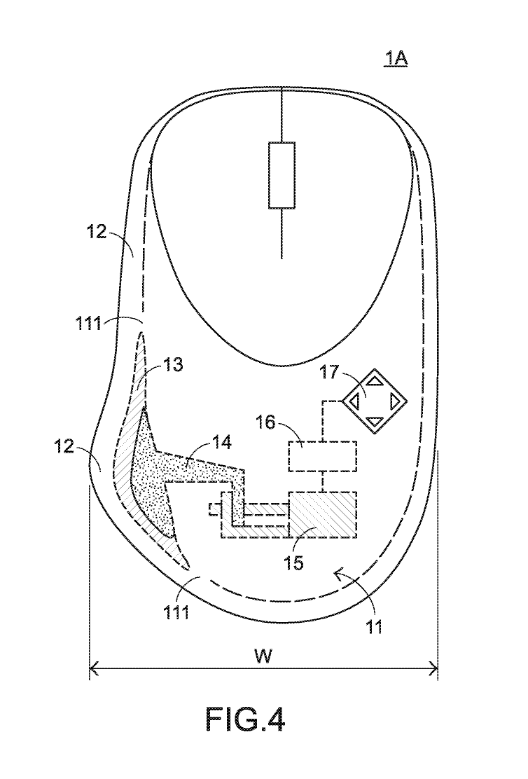

In detail, refer to FIG. 4 at the same time, FIG. 4 is a schematic structural diagram of the mouse device shown in FIG. 2 that is adjusted by a user. In a process that the user adjusts the volume and the size of the mouse device 1A by operating the control portion 17, the control portion 17 may generate and output a corresponding instruction signal Si to the processing unit 16; and the processing unit 16 subsequently drives the motor 15 to rotate in response to the instruction signal 51, so as to enable the linking structure 14 to move to change the abutting state that the support structure 13 abuts against the flexible film 12. In this preferred embodiment, the opening 111 of the housing 11 is located at a side edge of the housing 11. When the motor 15 provides a power to change the abutting state that the support structure 13 abuts against the flexible film 12, the flexible film 12 covering the opening 111 may be enabled to generate a deformation in a horizontal direction, for example, to convert from an appearance state of the mouse device 1A shown in FIG. 2 into an appearance state of the mouse device 1A shown in FIG. 4. Therefore, a maximum width W of the mouse device 1 may be increased or decreased in response to the deformation of the flexible film 12, so as to be fit for a size of the hand portion of the user.

Further, in this preferred embodiment, the flexible film 12 of the mouse device 1 is made of a silicone material. Moreover, the support structure 13 of the mouse device 1 is a flexible structure, and is made of, for example, a thermoplastic polyurethanes (TPU) material. The processing unit 16 may be a hardware component, a software component, or a firmware component, but is not limited thereto.

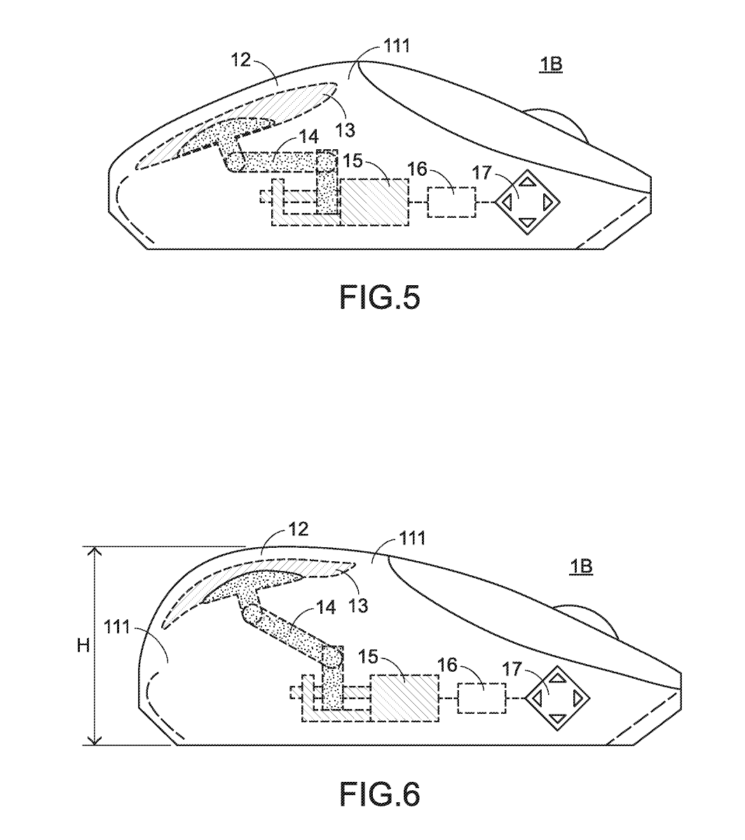

Referring to FIG. 5 and FIG. 6, FIG. 5 is a schematic structural diagram of a mouse device in a second preferred embodiment according to the present invention; and FIG. 6 is a schematic structural diagram of the mouse device shown in FIG. 5 that is adjusted by a user. A mouse device 1B in this preferred embodiment is substantially similar to the mouse device described in the first preferred embodiment of the present invention, and details are not described herein again. However, this preferred embodiment differs from the first preferred embodiment stated above in that: The opening 111 of the housing 11 is located above the housing 11; and when the motor 15 is driven to rotate, so as to move the linking structure 14 to change the abutting state that the support structure 13 abuts against the flexible film 12, the flexible film 12 covering the opening 111 may be enabled to generate a deformation in a vertical direction, for example, to convert from an appearance state of the mouse device shown in FIG. 5 into an appearance state of the mouse device 1B shown in FIG. 6. Therefore, a maximum height H of the mouse device 1B may be increased or decreased in response to the deformation of the flexible film 12, so as to be fit for the size of the hand portion of the user.

Certainly, the foregoing is merely an embodiment, and a person skilled in the art may make any equivalent modification or design according to the actual application requirements. For example, the mouse device may be modified and designed to be that the housing 11 has an opening 111 at the above and an opening 111 at a side edge at the same time, or the opening 111 at the above and the opening 111 at the side edge together form an opening 111 having a larger range; moreover, two motors 15, two linking structures 14, and two support structures 13 are disposed within the housing 11, or the two linking structures 14 share a power provided by a same motor 15. In this way, the user may adjust the maximum width W and the maximum height H of the mouse device by operating the control portion 17 of the mouse device, so as to be fit for the size of the hand portion of the user.

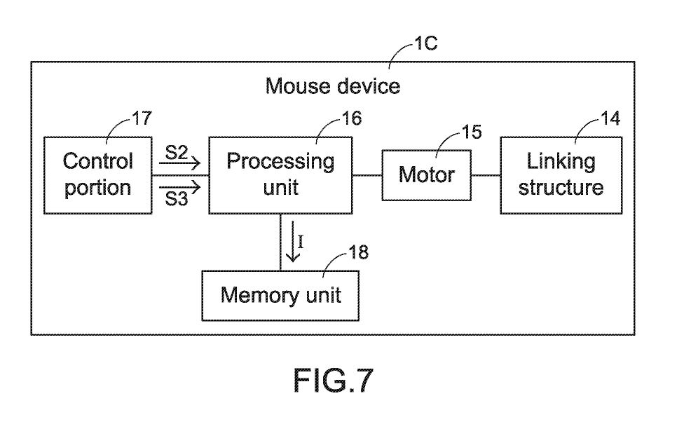

Referring to FIG. 7, FIG. 7 is a conceptual schematic block diagram of a mouse device in a third preferred embodiment according to the present invention. A mouse device 1C in this preferred embodiment is substantially similar to the mouse devices described in the first and the second preferred embodiments of the present invention, and details are not described herein again. However, this preferred embodiment differs from the first and the second preferred embodiments in that: When the user has adjusted the mouse device 1C to have a volume and size fitting for the user, the user may further record the current volume and size of the mouse device 1C by operating the control portion 17.

In this preferred embodiment, the mouse device 1C further includes a memory unit 18. The memory unit 18 may be a hardware component, a software component, or a firmware component, and is connected to the processing unit 16. When the user records the current volume and size of the mouse device 1C by operating the control portion 17, the control portion 17 may generate and output a recording instruction S2 to the processing unit 16; and the processing unit 16 subsequently records state data I of the mouse device 1C at this time (for example, state data of the motor 15 and/or position data of the linking structure 14, but is not limited thereto) into the memory unit 18 in response to the recording instruction S2, so as to record the abutting state that the support structure (not shown in FIG. 7, referring to FIG. 2 and FIG. 4 to FIG. 6) abuts against the flexible film (not shown in FIG. 7, referring to FIG. 2 and FIG. 4 to FIG. 6). Further, when the user restores the mouse device 1C to the volume and the size that are memorized by the user by operating the control portion 17 in the future, the control portion 17 may generate and output a restore instruction S3 to the processing unit 16; and the processing unit 16 subsequently drives, according to the state data I recorded in the memory unit 18, the motor 15 to rotate in response to the restore instruction S3, so as to restore the abutting state that the support structure abuts against the flexible film to a state memorized by the user.

However, the foregoing is merely an embodiment. The specific implementation manner of recording the volume and the size of the mouse device 1C and the specific implementation manner of restoring the mouse device 1C to the recorded volume and size are not limited to the above, and a person skilled in the art may make any equivalent modification or design according to the actual application requirements.

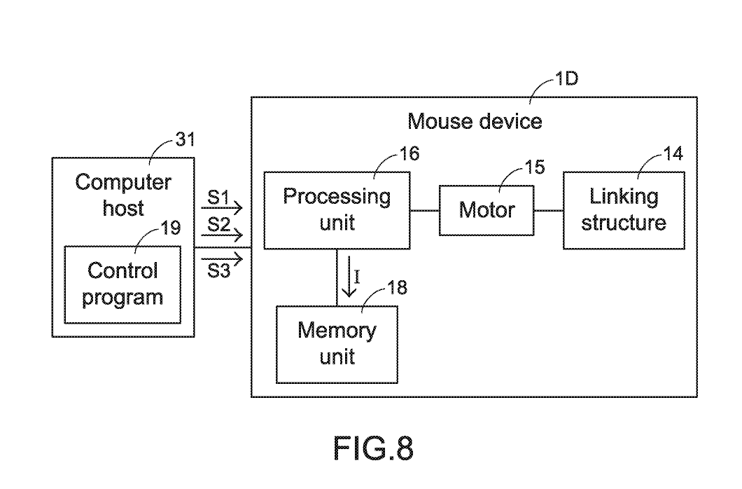

Referring to FIG. 8, FIG. 8 is a conceptual schematic block diagram of a mouse device in a fourth preferred embodiment according to the present invention. A mouse device 1D in this preferred embodiment is substantially similar to the mouse devices described in the first to the third preferred embodiments of the present invention, and details are not described herein again. However, this preferred embodiment differs from the first to the third preferred embodiments in that: The mouse device 1D further includes a control program 19; the control program 19 is configured to be installed in the computer host 31; and after the control program 19 is installed in the computer host 31, the user may adjust a volume and a size of the mouse device 1D, record the volume and the size of the mouse device 1D, and/or restore the mouse device 1D to the recorded volume and size by operating a user interface (not shown in the figure) of the control program 19.

In detail, in this preferred embodiment, in a process that the user adjusts the volume and the size of the mouse device 1D by operating the user interface of the control program 19, the control program 19 may enable the computer host 31 to generate and output a corresponding instruction signal S1 to the processing unit 16 of the mouse device 1D; and the processing unit 16 subsequently drives the motor 15 to rotate in response to the instruction signal S1, so as to enable the linking structure 14 to move to change the abutting state that the support structure (not shown in FIG. 8, referring to FIG. 2 and FIG. 4 to FIG. 6) abuts against the flexible film (not shown in FIG. 8, referring to FIG. 2 and FIG. 4 to FIG. 6).

Further, when the user records the volume and the size of the mouse device 1D by operating the user interface of the control program 19, the control program 19 enables the computer host 31 to generate and output a recording instruction S2 to the processing unit 16; and the processing unit 16 subsequently records the state data I of the mouse device 1 at this time (for example, the state data of the motor 15 and/or the position data of the linking structure 14, but is not limited thereto) into the memory unit 18 in response to the recording instruction S2, so as to record the abutting state that the support structure abuts against the flexible film.

Further, when the user restores the mouse device 1D to the volume and the size fitting for the user by operating the user interface of the control program 19 in the future, the control program 19 may enable the calculator device to generate and output a restore instruction S3 to the processing unit 16; and the processing unit 16 subsequently drives, according to the state data I recorded in the memory unit 18, the motor 15 to rotate in response to the restore instruction S3, so as to restore the abutting state that the support structure abuts against the flexible film to a state memorized by the user.

However, the foregoing is merely an embodiment. The specific implementation manners of adjusting the volume and the size of the mouse device 1D, recording the volume and the size of the mouse device 1D, and restoring the mouse device 1D to the recorded volume and size by operating the control program 19 are not limited to the above, and a person skilled in the art may make any equivalent modification or design according to the actual application requirements.

For example, the state data I of the mouse device 1D (for example, the state data of the motor 15 and/or the position data of the linking structure 14, but is not limited thereto) is not defined to be recorded in the memory unit 18 of the mouse device 1 by using the processing unit 16 of the mouse device 1. It may alternatively be modified and designed that the state data I of the mouse device 1D is recorded in the computer host 31 by using the control program 19 installed in the computer host 31. When the user restores the mouse device 1D to the volume and the size fitting for the user by operating the user interface of the control program 19 in the future, the control program 19 may enable the computer host 31 to generate and output the restore instruction S3 and the related state data I to the processing unit 16; and the processing unit 16 subsequently drives the motor 15 to rotate in response to the restore instruction S3 and the related state data I, so as to restore the abutting state that the support structure abuts against the flexible film to the state memorized by the user.

According to the foregoing description, in a process of adjusting the volume and the size of the mouse device in the present invention, the appearance still keeps flat. Therefore, a touch sense of the user for operating the mouse device is not affected. Moreover, components within the mouse device are also protected, so as to achieve waterproof, dust-proof, and anti-static effects. Therefore, the mouse device has industrial value

The foregoing is merely the preferred embodiments of the present invention, and is not intended to limit the scope of the present invention. Therefore, any other equivalent replacement or modification made without departing from the spirit disclosed by the present invention shall fall within the scope of the present invention.

What is claimed is:

1. A mouse device, comprising:
a housing, comprising an opening;
a flexible film, covering the opening;
a support structure, abutting against the flexible film in a direction towards outside of the housing;
a linking structure, one side thereof being connected to the support structure; and
a motor, disposed in the housing and connected to another side of the linking structure, and configured to enable the linking structure to move to change an abutting state that the support structure abuts against the flexible film, thereby enabling the flexible film to deform.

2. The mouse device according to claim 1, wherein the flexible film at least covers a part of the housing.

3. The mouse device according to claim 1, wherein the flexible film is made of a silicone material.

4. The mouse device according to claim 1, wherein the support structure is a flexible structure.

5. The mouse device according to claim 4, wherein the support structure is made of a thermoplastic polyurethanes (TPU) material.

6. The mouse device according to claim 1, wherein a maximum width of the mouse device is increased in response to that the flexible film deforms, or a maximum height of the mouse device is increased in response to that the flexible film deforms.

7. The mouse device according to claim 1, further comprising a processing unit that drives, in response to an instruction signal, the motor to rotate, so as to enable the linking structure to move to change the abutting state that the support structure abuts against the flexible film.

8. The mouse device according to claim 7, further comprising a control portion that is connected to the processing unit, and is operated by a user to generate and output the instruction signal to the processing unit.

9. The mouse device according to claim 7, further comprising a control program that is installed in a calculator device connected to the mouse device, and is operated by a user to enable the calculator device to generate and output the instruction signal to the processing unit.

10. The mouse device according to claim 7, further comprising a control program connected to a control portion of the processing unit or configured to be installed in a calculator device, wherein the control program is operated by a user to record the abutting state that the support structure abuts against the flexible film.
